(19) United States
(12) Patent Application Publication
(10) Pub. No.: US 2022/0350586 A1
(43) Pub. Date: Nov. 3, 2022

(54) Methods of Distributing Software/Firmware Updates

(71) Applicant: Arm Cloud Technology, Inc., San Jose, CA (US)

(72) Inventors: Brendan James Moran, Histon (GB); Adrian Laurence Shaw, Cambridge (GB)

(73) Assignee: Arm Cloud Technology, Inc., San Jose, CA (US)

(21) Appl. No.: 17/245,117

(22) Filed: Apr. 30, 2021

(51) Int. Cl. G06F 8/65; G06F 8/61; G06F 21/57; G06F 21/44; H04L 29/08

(52) U.S. Cl. CPC G06F 8/65; G06F 8/61; G06F 21/572; G06F 21/44; H04L 67/06

(57) ABSTRACT

The present disclosure relates to a computer-implemented method of distributing a delta update of a firmware, comprising: sending a first verification request to a device for a first attestation report generated based on an existing version of the firmware installed on the device; receiving a first evaluation for the first attestation report from a trusted third party; determining based on the first evaluation whether the device is secure; and sending a delta update to the device upon determining that the device is secure.

### FIELD

The present technology relates to distribution of software and/or firmware updates to electronic devices.

### BACKGROUND

Cloud computing services have become commonplace in recent years. More and more devices are now connected to the cloud, for example as part of the “Internet of Things” (IoT). Devices ranging from personal computers, smartphones, to relatively small devices such as temperature sensors, healthcare monitors and electronic door locks can be connected to the cloud so that they can be accessed, controlled and updated using remote systems.

All electronic devices consume resources in the form of power, communication bandwidth over buses and networks, memory footprints, storage requirements, redundancy and backup requirements, and the like. Relatively small devices are often constrained in battery power, network bandwidth, memory allocation and other resources and such constrained resources present problems to developers of such systems.

A differential update, also known as a delta update, is an update comprising only the code of a program that has changed. Updating a program this way is desirable since a user is only required to download the update as opposed to the whole program. In general, processes for computing a differential update between a current version and a desired version can use a program such as bsdiff to compute a table of copies, insertions, and differences, and a sequence of instructions that use these tables to transform a current software image into a desired software image. The tables are then compressed with a standard compression algorithm to produce a software image, with the expectation that the majority of changes would be copies, few insertions, and where there are differences, they will comprise many similar numbers, which would compress well.

When a firmware or software update becomes available, devices that have installed thereon a version of the firmware or software may request the update. In conventional update systems, little authentication is performed on the requesting device. Some update systems may simply send the update to any device that requests it. Other update systems may perform some form of verifications such as verifying that the requesting device is onboard a management system that only admit devises from trusted vendors, or requesting proofs of possession of the requesting device e.g. using public key cryptography based on a key held by the device.

There may be security risks associated with these conventional approaches which a threat actor may exploit, for example by extracting identity or duplicating keys to bypass such verifications or proofs of possession. Moreover, in cases where a device is corrupted and require recovery, the identity storage system may also have been corrupted and rendering the device inoperable.

### BRIEF DESCRIPTION OF THE DRAWINGS

Embodiments will now be described, with reference to the accompanying drawings, in which:

FIG. 1 shows a block diagram of an exemplary implementation of the present technology;

FIG. 2 shows an exemplary process of an update distribution;

FIG. 3 shows an exemplary process of an update distribution involving firmware recovery;

FIG. 4 shows a flow diagram of an exemplary method of distributing an update; and

FIG. 5 shows a flow diagram of an exemplary method of obtaining an update.

### DETAILED DESCRIPTION

In view of the foregoing, it is desirable to provide an improved method of distributing a software/firmware update.

In view of the foregoing, an aspect of the present technology provides a computer-implemented method of distributing a delta update of a firmware, comprising: sending a first verification request to a device for a first attestation report generated based on an existing version of the firmware installed on the device; receiving a first evaluation for the first attestation report from a trusted third party; determining based on the first evaluation whether the device is secure; and sending the delta update to the device upon determining that the device is secure.

According to embodiments of the present technology, an attestation report of the existing version of the firmware installed on a device is requested when a delta update of the firmware is available, and the attestation report is evaluated, not at the device or by the update server, but by a trusted third party (e.g. the silicon manufacturer). The present approach thus reduces or removes the risk of a verification or authentication process being tampered with by a threat actor or attacker at the device. In approaches where identities (e.g. private keys) and/or secure boot trust anchors are used as means for verification of the device, these must be provisioned after the manufacturing of the silicon chip of the device to allow for customer personalisation. As such, these keys are exposed to higher risk levels in that they could be manipulated or copied. On the other hand, Remote Attestation keys can be stored on the silicon chip during manufacturing and made inaccessible to the processor, and used only for generating attestation reports. Thus, Remote Attestation keys cannot be manipulated or copied. Moreover, unlike the process of a secure boot, fault injection, a practice in which the device is exposed to a burst of radiation at a specific moment during a secure boot to force the bootloader to bypass a particular instruction, cannot circumvent attestation as attestation is not evaluated locally at the device. Lastly, as the attestation report is generated based on the existing version of the firmware installed and running on the device and cannot be tampered with, the evaluation of the attestation report provides a way to explicitly evaluate the trustworthiness of the device (e.g. by evaluating the attestation report against an expected set of measurements of the firmware) instead of an indirect evaluation of trustworthiness based on an implication of device security when the device completes a secure boot. By relying on a trusted third party to perform the evaluation, the present approach decouples the process of verifying a device from the provision of verification data at the device, thus reducing the risk of tampering at the device. The update server can then receive an evaluation on the attestation report directly from the trusted third party and only sends the requested delta update is the device is determined to be trustworthy and secure.

In some embodiments, the first attestation report may be generated further based on a configuration of the firmware installed on the device. By requesting an attestation report based not only the version of the firmware but also on the configuration of the firmware, it is possible to evaluate the trustworthiness of the device further.

In some embodiments, the method may further comprise determining based on the first evaluation whether the configuration of the firmware installed on the device corresponds to an expected configuration. By evaluating the configuration of the firmware installed on the device against an expected set of configurations, it is possible to quickly and effectively evaluate the trustworthiness of the device.

In some embodiments, the method may further comprise, upon determining that the configuration of the firmware installed on the device does not correspond to the expected configuration, sending a factory reset request to the device to perform a configuration factory reset. By forcing the device to perform a factory reset on the version of firmware installed on the device to bring the configuration of the firmware to the original factory setting, it is possible to ensure that the device has a secure version of the firmware before sending the delta update to the device.

There may be occasions in which the existing version of the firmware installed on the device is not the latest version of the firmware, for example if the device has been in storage before being sold or if the device or the firmware on the device has been corrupted and a recovery firmware has been installed. In these cases, the version of the firmware currently installed on the device may be an older version of the firmware with known vulnerabilities. Thus, in some embodiments, determining whether the device is secure may comprise determining whether the existing version of the firmware installed on the device is a secure version of the firmware.

In some embodiments, the method may further comprise, upon determining that the existing version of the firmware installed on the device is not a secure version of the firmware, sending an intermediate update of the firmware to the device to bring the existing version of the firmware to an intermediate version of the firmware that corresponds to a secure version. On occasions where it is determined that the existing version of the firmware installed on the device is not a secure version of the firmware, e.g. an older version of the firmware with known vulnerabilities, the update server can first send an intermediate update to the device to bring the existing version of the firmware to an intermediate version of the firmware that does not have these vulnerabilities before sending the requested delta update. In doing so, it is possible to ensure that the version of the firmware on the device is secure.

In some embodiments, the method may further comprise, after sending the intermediate update of the firmware to the device, sending a second verification request to the device for a second attestation report generated based on the intermediate version of the firmware.

In some embodiments, the method may further comprise receiving a second evaluation for the second attestation report from the trusted third party, and determining based on the second evaluation whether the device is secure. By requesting a further attestation report from the device after sending an intermediate update to the device, and receiving an evaluation on the further attestation report from the trusted third party, it is possible to confirm that the intermediate version has been installed correctly on the device, and that the device is indeed secure, before proceeding with sending the requested delta update.

In some embodiments, the method may further comprise receiving an update request from a device for the delta update, wherein sending the first verification request to a device for a first attestation report is performed responsive to the update request.

In some embodiments, the method may further comprise receiving an identifier from the device indicating an identity of the device. This may be done before attestation, e.g. the device user may be requested to login upon requesting the delta update, or after attestation, e.g. upon determining that the device is secure based on the evaluation on the attestation report.

In some embodiments, the method may further comprise verifying the identity of the device and aborting sending the requested delta update to the device when the identity of the device cannot be verified. If the identity of the device user or the device cannot be verified, e.g. the device user failed to provide the correct login name and/or password, the update server can abort sending the requested delta update to the device even when the evaluation of the attestation report determines the device to be secure.

Another aspect of the present technology provides a non-transitory computer-readable storage medium having stored thereon software instructions that, when executed by a computer, cause the computer to: send a verification request to a device for an attestation report generated based on an existing version of the firmware installed on the device; receive an evaluation for the attestation report from a trusted third party; determine based on the evaluation whether the device is secure; and send a delta update to the device upon determining that the device is secure.

A further aspect of the present technology provides a data processing device comprising: processing circuitry; and non-transitory computer-readable memory having stored thereon software instructions that, when executed by the processing circuitry, cause the data processing device to: send a verification request to a device for an attestation report generated based on an existing version of the firmware installed on the device; receive an evaluation for the attestation report from a trusted third party; determine based on the evaluation whether the device is secure; and send a delta update to the device upon determining that the device is secure.

In a complimentary aspect, the present technology provides a computer-implemented method of obtaining a delta update of a firmware from an update server, the method being performed by a device having installed thereon an existing version of the firmware, the method comprising: receiving a first verification request from the update server to generate a first attestation report based on the existing version of the firmware; and sending the first attestation report to a trusted third party for evaluation.

According to embodiments of the present technology, a device is required to generate an attestation report based on the existing version of a firmware and send the attestation report to a trusted third party for evaluation before it can obtain a delta update of the firmware. Thus, it is possible to ensure that the device is secure before receiving and installing a delta update.

In some embodiments, the method may further comprise receiving the delta update from the update server and updating the existing version of the firmware installed on the device using the received delta update.

In some embodiments, the first attestation report may be generated further based on a configuration of the firmware installed on the device.

In some embodiments, the method may further comprise, after sending the first attestation report to the trusted third party for evaluation, receiving from the update server a factory reset request to perform a configuration factory reset.

In some embodiments, the method may further comprise performing the configuration factory reset and sending a confirmation to the update server indicating that the configuration factory reset is completed.

In some embodiments, the method may further comprise, before sending the first request to the update server to receive the delta update, detecting a fault in the existing version of the firmware installed on the device, and initiating a recovery mechanism to obtain recovery firmware from a location other than the update server and installing the recovery firmware, wherein the first attestation report is generated based on the recovered version of the firmware. There may be instances when the firmware running on the device is corrupted. In these cases, the device may initiate a recovery mechanism to install recovery firmware on the device, then request a delta update of the firmware to bring the firmware up to date.

In some embodiments, the method may further comprise receiving from the update server an intermediate update of the firmware to the device to bring the existing version of the firmware to an intermediate version of the firmware.

In some embodiments, the method may further comprise updating the existing version of the firmware to the intermediate version using the intermediate update.

In some embodiments, the method may further comprise generating a second attestation report based on the intermediate version of the firmware and sending the second attestation report to the trusted third party for evaluation.

In some embodiments, the method may further comprise sending a first update request to the update server to receive the delta update.

In an example, after a device is manufactured it may be provisioned with a trusted public key which is rotated in all active devices, and to be used together with a private key specific to the device user to identify the device. At this point, the device has a legitimate identity and a legitimate firmware. Then, at a later point, the original private key is compromised, e.g. leaked to a threat actor. Using the compromised private key, the threat actor is able to sign a malicious firmware using the identity of the device. The device may then report a legitimate identity and request a firmware update. After identity verification, the device is able to receive the update, but instead of installing the update on the device, the device transfers that update to the threat actor. The threat actor may then be able to reverse engineer the latest version of the firmware using the obtained update and/or look for vulnerabilities to exploit in a later larger scale attack.

The present approach uses the techniques of Remote Attestation to verify the trustworthiness of a device before responding to a request for an update of a firmware. The device is required to generate and send an attestation report based on the existing version of the firmware installed on the device to a trusted third party (e.g. the manufacturer of the silicon chip) for evaluation. The evaluation of the attestation report may for example include verifying whether the existing version of the firmware is legitimate, checking based on the identity of the silicon chip whether the device has been reported as lost or stolen, etc. The evaluation is sent to the update server who determines whether the device is trustworthy based on the evaluation, before sending (or not) the requested update to the device.

In Remote Attestation, one party (the “Attester”) generates information about itself (the “attestation report”) to enable a remote party (the “Relying Party”) to decide whether to consider that Attester a trustworthy party or not. Remote Attestations are facilitated by a Verifier, who appraises the attestation report via predetermined appraisal policies and generates Attestation Results to support the Relying Party in their decision process.

The goal of remote attestation is to enable the Relying Party to determine the level of trust in the integrity of the platform of the Attester's system. In particular, remote attestation allows changes to the Attester device to be detected by authorized trusted parties. For example, software companies may identify unauthorized changes to their software, including tampering of their software to circumvent technological protection measures. It general, the hardware of the device generates a certificate (the “attestation report”) stating what software is currently running on the device. The Attester device can then present this attestation report to a trusted third party to prove that the software/firmware that is currently executing on the device is unaltered.

Remote attestation can be used in combination with public-key encryption so that the information sent and received between the Attester, the Relying Party and the Verifier can only be read by the relevant and not by an eavesdropper.

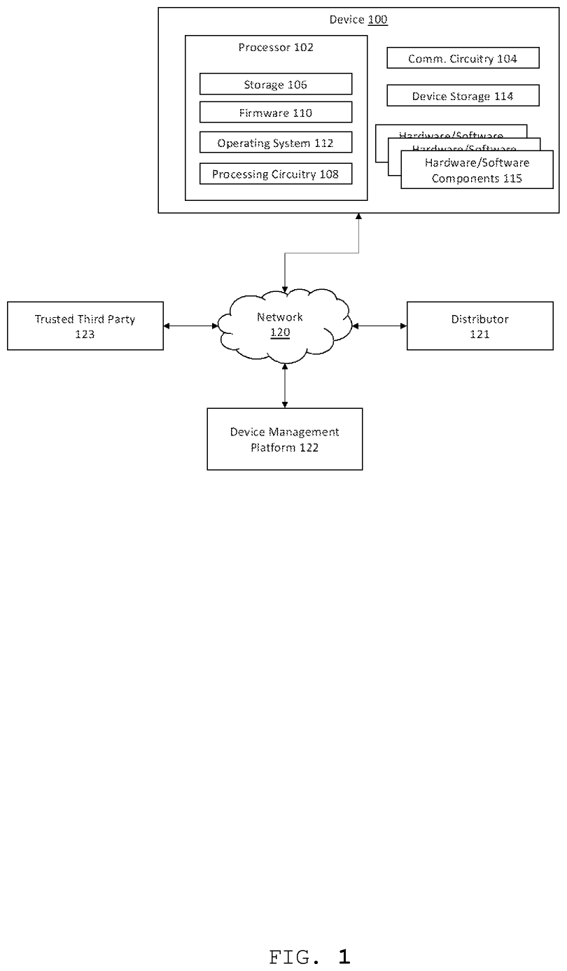

FIG. 1 shows an example of a system overview suitable for implementing embodiments of the present technology.

An electronic device 100 is shown in FIG. 1 as being connected to a first entity 121 (“distributor”) that is a storage location remote from the device 100 (e.g. a server), a second entity 122 (“device management platform” (DMP)) from which a software or firmware updated may be obtained, and a third entity 123 (“trusted third party”) such as a silicon manufacturer through a communication network 120. It should be noted that numerous other general purpose or special purpose computing system environments or configurations may be deployed to implement the present technology. Examples of well-known computing processing systems, environments, and/or configurations that may be suitable for use with device 100 include, but are not limited to, gateways, routers, personal computer systems, server computer systems, thin clients, thick clients, hand-held or laptop devices, multiprocessor systems, microprocessor-based systems, set top boxes, programmable consumer electronics (smartphones, smart watches, tablets), network PCs, minicomputer systems, mainframe computer systems, and distributed computing environments that include any of the above systems or devices.

The device 100, distributor 121, DMP 122 and trusted third party may be described in the general context of computer systems and computer systems on a chip (SoC). Such computer systems comprise executable instructions, such as program modules, being executed by a computer processor. Generally, program modules may include routines, programs, objects, components, logic, and/or data structures that perform tasks or implement abstract data types.

The communication network 120 may be any suitable type of network including a wide area network (WAN), a cloud computing environment, etc. In embodiments the network may be a private network.

As will be apparent, the distributor 121 is an optional entity and the resources (e.g. recovery software/software manifests) provided by the distributor 121 may be stored locally at the device 100 (e.g. in storage thereon or via short range communications (e.g. Bluetooth, NFC etc.)).

The device 100 comprises a processor 102, communication circuitry 104, and a device storage 114.

The processor 102 is configured to load machine instructions from the device storage 114 and to perform machine operations in response to the machine instructions. The communication circuitry 104 is configured to enable communication between the device 100 and other entities (e.g. the distributor 121 and/or DMP 122 and/or the trusted third party 123). The communication circuitry 104 may use wireless communication, such as communication using wireless local area network (Wi-Fi), short range communication such as radio frequency communication (RFID) or near field communication (NFC), communications used in wireless technologies such as ZigBee, Thread, Bluetooth, Bluetooth LE, IPv6 over Low Power Wireless Standard (6LoWPAN), a cellular network such as 3G or 4G, or a wired communication such as using a fibre optic or metal cable, or a combination thereof.

The processor 102 comprises processor storage 106, processing circuitry 108, firmware 110, and operating system 112.

The processing circuitry 108 is configured to process instructions and comprises, for example, fetch circuitry for fetching instructions, decode circuitry for decoding instructions, and execution circuitry for executing instructions (not shown). Data and program code stored in the device storage 114 are accessible to the processing circuitry 108.

The processor storage 106 (e.g. volatile memory such as RAM) provides the execution environment for processor 102 and space for the program instructions for the firmware 110 and operating system 112. Processor storage may also include one or more processor registers which store information written, for example, by an application or component. Such information may, for example, be one or more bit values or a flag.

The firmware 110 may comprise an operating kernel program for running one or more processes and environments. The firmware 110 can be embodied in circuitry or program instructions in processor storage 106. For example, bootloader firmware (hereafter Bootloader) may locate a system image of an executable system or application (e.g. client application), load it into processor storage, and pass control to that executable system or application. The executable system or application operates at the software level of the hardware-firmware-software stack. The executable system typically comprises an operating system, peripheral device control programs, system utilities such as data access methods and any ready-to-run device application programs. In some embodiments, the system image comprises a dedicated operating system and code that may be tailored to a particular set of functions which the device is to perform (e.g. to connect and register to a particular server or service).

The operating system 112 is a system for loading and executing program modules and can be embodied in circuitry or program instructions in processor storage.

The device 100 may have hardware/software components 115 having associated software (e.g. firmware) to enable the components 115 to function.

Such components may comprise a radio module, camera, GPS module although the claims are not limited in this respect.

The device 100 may further comprise credential data provisioned in device storage 114, for example, during factory setup or on deployment. Such credential data may include but is not limited to certificates (e.g. X.509 certificates), cryptographic keys (e.g. symmetric and/or asymmetric keys), etc. The credential data may be used as an input to a security protocol to establish a secure communications channel with a remote resource. Such a security protocol may, for example, comprise Transport Layer Security/Datagram Transport Layer Security (TLS/DTLS), whereby TLS/DTLS is used to provide a secure channel between the device 100 and a remote 15 entity, whereby TLS/DTLS security modes include both pre-shared key and public key technology. The data protected by TLS/DTLS may be encoded as plain text, binary TLV, JSON, CBOR, or any other data exchange formats.

The distributor 121, DMP 122 and the trusted third party 123 are similarly operational with numerous other general purpose or special purpose computing system environments or configurations and are typically servers, comprising computer components such as those described for device 100 but these are not shown nor described in any great detail. Such servers may be discrete entities or may comprise two or more distributed entities.

In the present example, the distributor 121 may be a public facing server with which a device communicates. The device 100 may connect to the distributor anonymously such that that device 100 does not establish a secure or encrypted connection with the distributor 121. The distributor 121 may transfer information (e.g. recovery software) to the device 100 using any suitable protocol, such as via file transfer protocol (FTP) although the claims are not limited in this respect.

In an example, the distributor 121 may authenticate a device before provisioning information thereto. For example, the device 100 may connect to the distributor 121 by establishing a secure connection with the distributor 121 using credential data thereon, such that any information exchanged between the device and distributor is secure. For example, communications between the device 100 and the distributor 121 may be encrypted and/or the device 100 may verify signatures on communications from the distributor to determine that the communications were signed by the trusted distributor 121.

The DMP 122 is an entity trusted by device 100. Such trust may be established on the basis of cryptographic keys provisioned on the device 100 (e.g. during a bootstrap process) although the claims are not limited in this respect and Message Authentication Code (MAC) values or other trust anchors may be used to establish trust. The device 100 verifies signatures on communications from the DMP 122 to determine that the communications were signed by the DMP 122. Additionally, or alternatively, the device 100 can decrypt communications encrypted by the DMP 122. In embodiments the device 100 can sign/encrypt communications that can be verified/decrypted by the DMP 122. Thus, communications between the device and DMP 122 are generally considered to be secure and trusted (unless the cryptographic keys provisioned to the device 100 or other trust anchors have been compromised).

When turned on the device will execute bootloader code which will, in turn, initiate a client application required for operation of the device 100. For example, the client application may comprise an operating system (OS) (e.g. Real Time OS) and other code to provide desired functions such as networking stacks, security stacks etc. In the present embodiments the client application runs on the device 100 and connects to the DMP 122 by establishing a secure communications channel therewith as described above.

The trusted third party 123, e.g. the manufacturer of the silicon provisioned to the device 100, is an entity trusted by both the device 100 and the DMP 122. The trusted third party 123 can act as a verifier between the device 100 and the DMP 122, by evaluating an attestation report generated by the device 100 and providing results of the evaluation to the DMP 122. Evaluations of an attestation report may include verifying the authenticity of the device, verifying the version of a firmware/software running on the device, evaluating the configuration of the firmware/software, checking whether the device has been reported missing/stolen, etc.

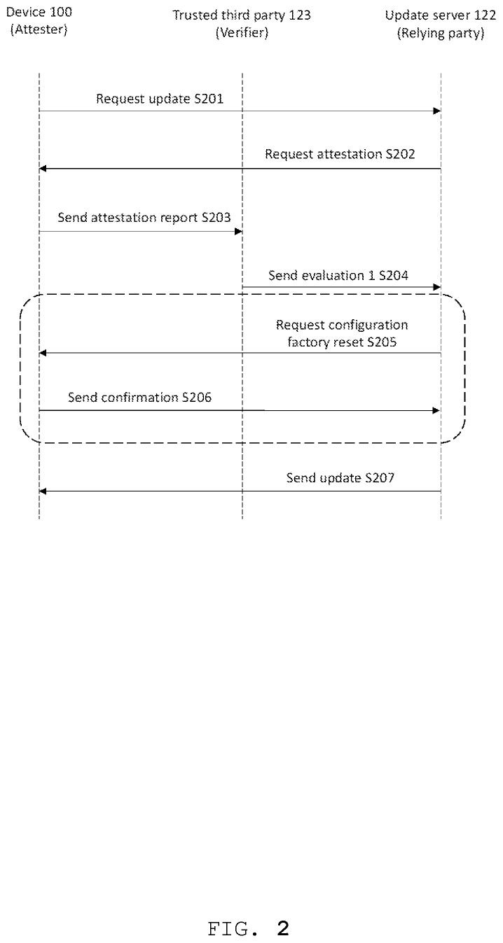

FIG. 2 illustrates an exemplary process for distributing a software/firmware update according to an embodiment. It should be noted that method steps bounded by dashed lines are optional.

The process begins at S201 when update server (e.g. the DMP 122) receives an update request from the device 100 to request an update for a firmware running on the device 100.

In response to the update request, the update server 122 sends a request for remote attestation to the device 100 at S202.

Upon receiving the request for remote attestation, the device 100 generates an attestation report for the version of the firmware running on the device 100. Optionally, the attestation report may be generated also for the configuration of the firmware running on the device 100. The device 100 then sends the thus generated attestation report at S203 to the trusted third party 123.

The trusted third party 123 evaluates the attestation report received from the device 100 and sends the evaluation to the update server 122 at S204. The evaluation may for example include verifying the authenticity of the device (not a copy of an authentic device), verifying the version of a firmware/software running on the device, evaluating the configuration of the firmware/software, checking whether the device has been reported missing/stolen, etc.

The update server 122 then determines, based on the evaluation from the trusted third party 123, whether the device 100 is trustworthy. For example, the update server 122 may check that the device is authentic, that the version of the firmware/software for which an update is requested is a secure version of the firmware/software, and that the configuration of the firmware/software meets an expected set of measurements. Upon determining that the device 100 is trustworthy, the update server 122 sends the requested update to the device 100 at S208.

There may be instances when the device 100, based on the evaluation from the trusted third party 123, is deemed authentic but the configuration of the firmware/software running on the device 100 does not meet an expected set of measurements. This may simply be a result of an error in the configuration or it may be an indication of malicious activities. As such, in an example, the update server 122 optionally sends a request for a configuration factory reset at S205 to the device 100 to force the device 100 to reset the configuration of the firmware/software to factory setting.

Upon receiving the request, the device 100 performs a configuration factory reset and optionally sends a confirmation to the update server 122 at S206. Then, upon receiving the confirmation from the device 100, the update server 122 can send the requested update to the device 100 at S207.

Alternatively, the device 100 may instead be required to send a further update request to the update server 122, and upon receiving the request, the update server 122 may send a further request for attestation to the device 100. The process then continues from S202.

As explained above, attestation keys are secured at a low level and cannot be accessed or modified at the device, an attestation report therefore cannot be tampered with at the device. As the evaluation of an attestation report is performed by a trusted third party remote from the device, the evaluation cannot be tampered with at the device. Thus, the present approach enables the update server to explicitly determine whether the device is trustworthy through the use of attestation reports before sending an update. This is particular important for maintaining the security of the software by reducing the likelihood of the update being obtained by a potential attacker, and/or when distributing software and/or updates containing proprietary intellectual property for prevention of copying. Moreover, where the device is required to construct an attestation report of the configuration of the software as well as the version of the software, it is possible to evaluate and determine whether the version of software running on the device has been configured as expected. In cases where the configuration of the software running on the device does not match an expected set of measurements, the update server can request the device to perform a factory reset on the configuration of the software to ensure that the version of the software installed on the device is secure before sending the update to the device.

There may be occasions when a fault occurs in a client application(s) on a device and the device cannot operate as expected, then some remedial action may be required. For example, the fault may be a system termination fault such that the client application does not start correctly, and the device does not reach an operational state. There may also be occasions when a device has a much older version of the client application, for example when the device is held in stock for a long time before being deployed. In the present embodiment, the device 100 is configured (e.g. during a factory install or during deployment) with a rescue or recovery mechanism to enable a device to obtain recovery software.

Such a rescue or recovery mechanism may for example comprise provisioning the device 100 with a recovery manifest e.g. stored in the device storage 114 of the device 100, wherein the recovery manifest includes information that enable the device to obtain recovery software. For example, the information in the recovery manifest may include an identifier corresponding to a recovery location from which the device can obtain the recovery software. In some embodiments, the credential data necessary to communicate with an entity at the recovery location may be provided in the recovery manifest. Such credential data, for example, may comprise a username for an FTP connection.

In some embodiments, the recovery location may correspond to a remote apparatus (e.g. a server), whereby the location identifier may comprise any suitable identifier which is used to locate a resource such as a Uniform Resource Identifier (URI), Uniform Resource locator (URL), Uniform Resource Name (URN) etc. Additionally, or alternatively, the recovery location may be a location local to the device such as the location (e.g. memory address) in device storage 114 at the device (e.g. non-volatile memory (NVM) such as serial peripheral interface (SPI) flash or other suitable non-volatile memory).

The recovery manifest may include verification data to enable the device to verify the integrity of the recovery software obtained from the recovery location. In some embodiments, the verification data may comprise, for example, a hash or digest corresponding to the recovery software, whereby the device may verify that a digest of a subsequently received recovery software matches the digest specified in the manifest. When the digests match the device can trust the recovery software; when the digests do not match the device can discard the recovery software received and attempt to obtain the recovery software again. The verification data may, additionally or alternatively, comprise information about the recovery software itself. For example, the verification data may specify a size of the expected recovery software so that the device does not write more data than required when it installs the recovery software.

Thus, according to the present embodiment, the device is configured to use in-place differential update, and its reliability backup plan is to use a bootloader that can download a generic recovery image (recovery software) from nearby infrastructure. The image is transmitted over and insecure medium in order to limit the code size required to support the acquisition of the recovery image.

Once the recovery image is installed, the device can then negotiate the download of an update for the recovery software.

However, during the recovery process, if the recovery software is intercepted and modified, the proprietary software and any personalization or identity information stored on the device may be exposed to threats. A threat actor may keep a device offline or obtain an old device in order to obtain a device with a digest for a recovery image that has a known vulnerability. In cases where recovery image digest is “burned” into the bootloader, the recovery software cannot be modified at the device and as such, it may not be possible to update the recovery image to e.g. fix security flaws, thus exposing the proprietary software and any personalization or identity information stored on the device to similar threats. Where the recovery image digest can be updated, it can be corrupted by a failure or be replaced by a threat actor.

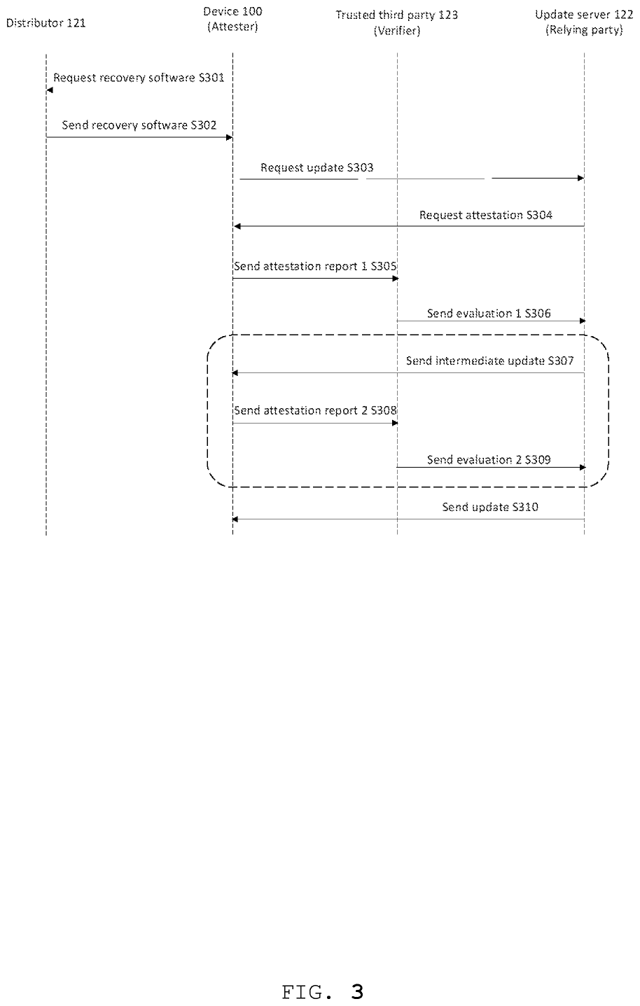

FIG. 3 illustrates an exemplary process for distributing a software/firmware update to a device having installed thereon such a recovery software according to an embodiment. It should be noted that method steps bounded by dashed lines are optional.

Upon detecting a fault in a client application, the device 100 initiates a recovery mechanism. At S301, the device requests recovery software from distributor 121, e.g. based on a recovery location included in a recovery manifest stored on the device storage 114.

As S302, the distributor 121 sends the requested recovery software to the device 100 according to predetermined protocols, and the device 100 installs the recovery software thereon.

Then, at S303, the device 100 sends an update request to the update server 122 for an update for the software to bring it to an up-to-date version.

Upon receiving the update request from the device 100, the update server 122 sends a request at S304 to the device 100 for an attestation report on the software running on the device 100, and optionally on the configuration of the software.

In response to the request, the device 100 constructs an attestation report on the software running on the device 100, and sends at S305 the attestation report to the trusted third party 123 for evaluation. The attestation report may be constructed for the bootloader, the recovery software, and optionally configuration data of the software.

The trusted third party 123 evaluates the attestation report received from the device 100 and sends the results of the evaluation to the update server 122 at S306. The results of the evaluation, in the present embodiment, may indicate that the version of the software is a recovery software.

Based on the results of the evaluation received from the trusted third party 123, the update server 122 may determine whether the device 100 is trustworthy (e.g. whether the version of the software running on the device 100 is secure and configured as expected). If the update server 122 determines that the device 100 is trustworthy, then at S310, the update server 122 sends the update to the device 100.

On the other hand, the update server 122 may determine that the recovery software installed on the device 100 is an older version of the software with known vulnerabilities. In this case, the update server 122 may first send an intermediate update to the device at S307 to bring the recovery software to a newer more secure intermediate version.

Upon receiving the intermediate update, the device 100 performs an intermediate update on the recovery software, then constructs and sends a further attestation report to the trusted third party for evaluation at S308. The intermediate update received from the update server may optionally include or be accompanied by a request for attestation to prompt the device 100 to construct and send an attestation report following the intermediate update.

The trusted third party 123 evaluates the further attestation report and sends the results of the evaluation to the update server 122.

Based on the results of the evaluation, the update server 122 can determine whether the present version of the software running on the device 100 is secure and configured as expected, then sends the update to the device 100 at S310 when it determines that the device is now secure.

According to the present embodiment, when a fault occurs in a client application on a device and a recovery software is installed on the device, remote attestation on the software is performed before an update for the software can be obtained. In doing so, it is possible to reduce the likelihood of the latest version of the software being obtained by an unauthorized party e.g. by tampering with the recover software or the recovery image digest, while allowing legitimate devices with corrupted software or older less secure versions of the software to be brought up to date.

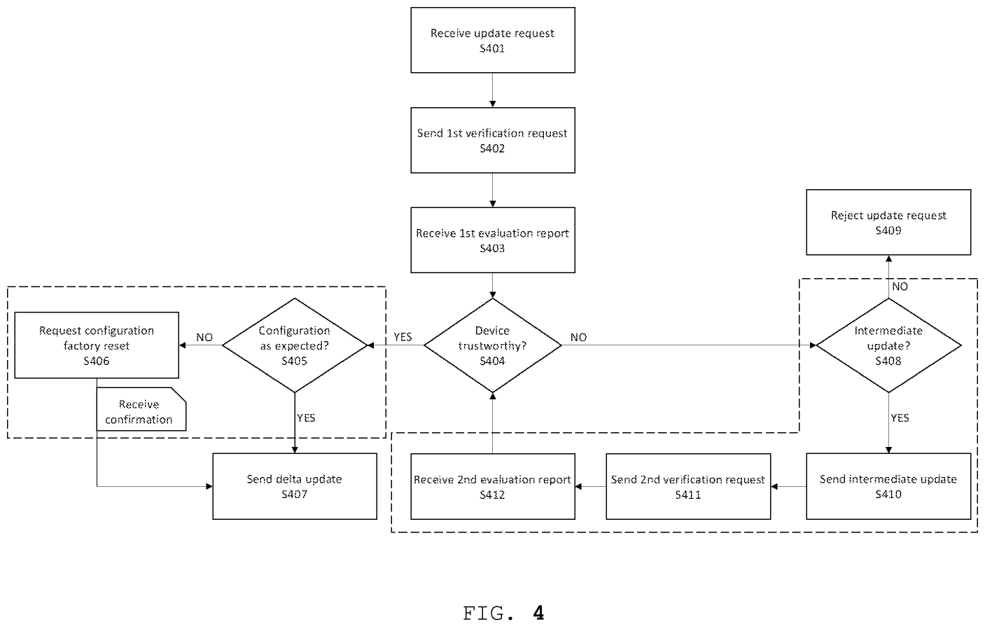

FIG. 4 illustrates an exemplary method of distributing a software/firmware update by an update server (e.g. the DMP 122), such as a delta update, to one or more devices according to an embodiment. It should be noted that method steps bounded by dashed lines are optional.

The method begins at S401 when the update server receives an update request from a device for an update of a software installed on the device. In response to the request, the update server sends a verification request at S402 to the device to request an attestation report to be constructed on the version of the software running on the device, and optionally on the configuration data of the software.

At S403, the update server receives results of an evaluation of the attestation report constructed by the device from a trusted third party (e.g. the silicon manufacturer of the device). Based in the results of the evaluation, the update server determines, at S404, whether the device is trustworthy, e.g. whether the version of the software running on the device is a secure version.

If the version of the software installed on the device is deemed secure, the update server may optionally determine at S405 whether the software is configured as expected, that the configuration data of the software matches an expected or a reference set of measurements. If the configuration data of the software matches the expected set of measurements, the update server then sends the requested delta update to the device at S407.

If the configuration data of the software does not match the expected set of measurements, the update server may request, at S406, the device to perform a configuration factory reset. Then upon receiving a confirmation that the reset has been performed, the update server may send the requested delta update to the device at S407.

If at S404 the update server determines that the device is not trustworthy, e.g. the version of the software running on the device is an older version of the software with known vulnerabilities, then at S408, the update server determines an intermediate update that can be sent to the device to bring the version of software installed on the device to a newer more secure intermediate version first. The update server then sends the intermediate update to the device at S410.

If at S404 the update server determines that the device is not trustworthy for other reasons that cannot be remedied by updating the software on the device to an intermediate version, then the update server may reject the update request at S409.

Upon sending the intermediate update, at S411, the update server may at the same time or additionally send a further (second) verification request to the device to request a further (second) attestation report following the intermediate update.

Upon receiving results of an evaluation on the further attestation report (second evaluation report) at S412, the update server again determines whether the device is now trustworthy, and proceeds to send the requested update to the device if the device is now deemed trustworthy, optionally following an evaluation of the configuration of the intermediate version of the software.

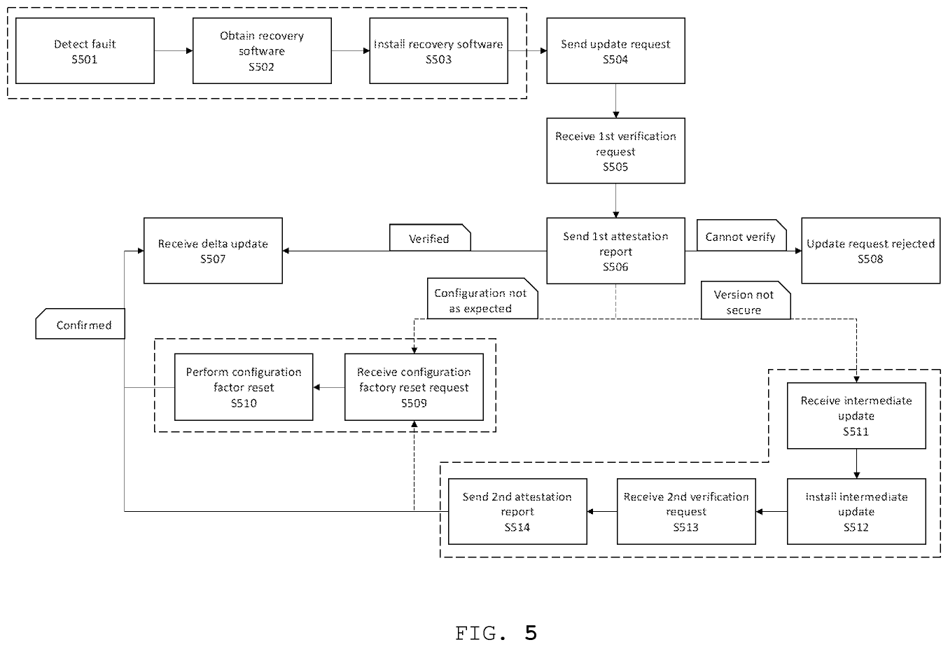

FIG. 5 illustrates an exemplary method of obtaining a software/firmware update by a device, such as a delta update, from an update server (such as the DMP 122) according to an embodiment. It should be noted that method steps bounded by dashed lines are optional.

The method may begin at S504 when the device sends an update request to the update server for a delta update of a software installed on the device. In some cases, the update request may be sent following a detection of a fault (e.g. corruption) at S501 in an application running on the device, in response to which the device initiates a recovery mechanism to obtain a recovery software S502 and installs the recover software on the device at S503.

At S505, following the sending of the update request, the device receives a verification request from the update server. In response, the device constructs an attestation report on the version of the software installed on the device and optionally the configuration data of the software, and sends, at S506, the attestation report to a trusted third party (or to the update server) for evaluation.

At this point, the update server may determine, based on the evaluation of the attestation report, that the device is not trustworthy (e.g. the device has been reported stolen) and reject the update request. Then, at S508, the device receives a rejection from the update server, optionally including a reason for the rejection.

If the evaluation of the attestation report verifies the authenticity and trustworthiness of the device, the device then receives the requested delta update at S507.

Optionally, the evaluation of the attestation report may identify one or more issues on the software installed on the device and the update server may attempt to remedy such issues before sending the requested update.

According to an embodiment, if the evaluation of the attestation report identifies that the configuration data of the software on the device does not match and expected set of configurations, the device may receive a configuration factory reset request at S509 from the update server to bring the configuration of the software in line with the expected set. Following performance of a configuration factory reset at S510, the device may send a confirmation to the update server to indicate that the reset has been performed. Then, at S507, the device receives the requested delta update from the update server.

In an embodiment, if the evaluation of the attestation report identifies that the version of the software on the device is not a secure version, e.g. an older version or a recovery version that has known vulnerabilities, the device may receive an intermediate update from the update server at S511 to bring the version of the software on the device up to an intermediate version that is more secure. The device may then install the intermediate update at S512. The device may receive a further (second) verification request at S513 from the update server either simultaneously with or following the intermediate update. Then, following the installation of the intermediate update, the device constructs a further (second) attestation report on the intermediate version of the software and sends the further attestation report at S514 for evaluation.

Upon the update server determining that the version of the software on the device is now secure and the device is trustworthy, the device can receive the requested delta update at S507 and update the intermediate version of the software to the requested version.

Optionally, based on the evaluation of the further attestation report, the update server may require the device to reset the configuration of the software if the configuration does not match and expected set, in which case the device receives a configuration factory reset request at S509. Upon performing the configuration factory reset at S510 and confirming that the reset has been performed, the device receives the requested update at S507.

In an alternative embodiment, the device 100 may construct an attestation report of a firmware installed on the device 100 and send the attestation report along with an update request for an update on the firmware to an update infrastructure that comprises the DMP 122 and the trusted third party 123, then the evaluation of the attestation report and the determination of whether the device 100 is trustworthy and therefore whether to send the requested update are performed within the update infrastructure.

Through the use of remote attestation to validate target environments before sending confidential data such as an update, it is possible to prevent or reduce leakage of security keys, identities, personal identifying information, and proprietary software/firmware to unknown or vulnerable devices. When a device downloads a recovery image from nearby infrastructure and installs the recovery image, the device is required to construct an attestation report on the software e.g. for the bootloader, recovery image and configuration data for evaluation by an update distribution infrastructure before an update of the software can be obtained. The update distribution infrastructure can then evaluate the target environment and if the recovery image has a known vulnerability, it can force an intermediate upgrade to a newer, more secure, version of recovery image first, and/or if the configuration data does not match an expected set, it can request a configuration factory reset at the device. In doing so, only once the version of the software on the device matches a predetermined combination of recovery image, bootloader and configuration data, in other words when the update distribution infrastructure is confident that a proprietary image will be securely installed by the attested recovery image, will the device be permitted to execute an update with the proprietary image.

Techniques describe herein enable an objective determination of the trustworthiness of a device when the device requests a delta update of a software installed thereon, through the use of remote attestation techniques that enables an update server to determine the security of the software installed on the device and optionally the configuration of the software based on an evaluation performed by a trusted third party. As such, techniques described herein removes the responsibility of verifying the authenticity of the device from the device itself and reduces the likelihood of tampering during such verification processes.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be clear to one skilled in the art that many improvements and modifications can be made to the foregoing exemplary embodiments without departing from the scope of the present techniques.

What is claimed is:

1. A computer-implemented method of distributing a delta update of a firmware, comprising:
sending a first verification request to a device for a first attestation report generated based on an existing version of the firmware installed on the device;
receiving a first evaluation for the first attestation report from a trusted third party;
determining based on the first evaluation whether the device is secure; and
sending the delta update to the device upon determining that the device is secure.

2. The method of claim 1, wherein the first attestation report is generated further based on a configuration of the firmware installed on the device.

3. The method of claim 2, further comprising determining based on the first evaluation whether the configuration of the firmware installed on the device corresponds to an expected configuration.

4. The method of claim 3, further comprising, upon determining that the configuration of the firmware installed on the device does not correspond to the expected configuration, sending a factory reset request to the device to perform a configuration factory reset.

5. The method of claim 1, wherein determining whether the device is secure comprises determining whether the existing version of the firmware installed on the device is a secure version of the firmware.

6. The method of claim 5, further comprising, upon determining that the existing version of the firmware installed on the device is not a secure version of the firmware, sending an intermediate update of the firmware to the device to bring the existing version of the firmware to an intermediate version of the firmware that corresponds to a secure version.

7. The method of claim 6, further comprising, after sending the intermediate update of the firmware to the device, sending a second verification request to the device for a second attestation report generated based on the intermediate version of the firmware.

8. The method of claim 7, further comprising receiving a second evaluation for the second attestation report from the trusted third party, and determining based on the second evaluation whether the device is secure.

9. The method of claim 1, further comprising receiving an update request from a device for the delta update, wherein sending the first verification request to a device for a first attestation report is performed responsive to the update request.

10. The method of claim 1, further comprising:
receiving an identifier from the device indicating an identity of the device;
verifying the identity of the device; and
aborting sending the requested delta update to the device when the identity of the device cannot be verified.

11. A data processing device comprising:
processing circuitry; and
non-transitory computer-readable memory having stored thereon software instructions that, when executed by the processing circuitry, cause the data processing device to:
send a verification request to a device for an attestation report generated based on an existing version of a firmware installed on the device;
receive an evaluation for the attestation report from a trusted third party;
determine based on the evaluation whether the device is secure; and
send a delta update to the device upon determining that the device is secure.

12. A computer-implemented method of obtaining a delta update of a firmware from an update server, the method being performed by a device having installed thereon an existing version of the firmware, the method comprising:
receiving a first verification request from the update server to generate a first attestation report based on the existing version of the firmware; and
sending the first attestation report to a trusted third party for evaluation.

13. The method of claim 12, further comprising receiving the delta update from the update server and updating the existing version of the firmware installed on the device using the received delta update.

14. The method of claim 12, wherein the first attestation report is generated further based on a configuration of the firmware installed on the device.

15. The method of claim 14, further comprising, after sending the first attestation report to the trusted third party for evaluation, receiving from the update server a factory reset request to perform a configuration factory reset.

16. The method of claim 15, further comprising performing the configuration factory reset and sending a confirmation to the update server indicating that the configuration factory reset is completed.

17. The method of claim 12, further comprising, before sending the first request to the update server to receive the delta update, detecting a fault in the existing version of the firmware installed on the device, and initiating a recovery mechanism to obtain recovery firmware from a location other than the update server and installing the recovery firmware, wherein the first attestation report is generated based on the recovered version of the firmware.

18. The method of claim 12, further comprising receiving from the update server an intermediate update of the firmware to the device to bring the existing version of the firmware to an intermediate version of the firmware.

19. The method of claim 18, further comprising updating the existing version of the firmware to the intermediate version using the intermediate update.

20. The method of claim 19, further comprising generating a second attestation report based on the intermediate version of the firmware and sending the second attestation report to the trusted third party for evaluation.
